(19) United States
(12) Patent Application Publication
(10) Pub. No.: US 2019/0045962 A1
(43) Pub. Date: Feb. 14, 2019

(54) LIGHT-BLOCKING WINDOW CURTAINS

(71) Applicant: Maytex Mills, Inc., New York, NY (US)

(72) Inventor: David Baines, Bedford, NY (US)

(21) Appl. No.: 16/057,996

(22) Filed: Aug. 8, 2018

Related U.S. Application Data
(60) Provisional application No. 62/542,651, filed on Aug. 8, 2017.

(51) Int. Cl. A47H 23/10; B32B 3/04; B32B 5/02; B32B 27/12; B32B 27/40; B32B 3/06; B32B 37/18

(52) U.S. Cl. CPC A47H 23/10; B32B 3/04; B32B 5/024; B32B 5/026; A47H 2023/025; B32B 27/40; B32B 3/06; B32B 37/182; B32B 27/12

(57) ABSTRACT

Light-blocking window curtains are disclosed having a light-blocking laminated layer comprising an outer fabric layer and a polymeric light-blocking layer, and an inner fabric layer spaced from the light-blocking laminated layer. The light-blocking laminated layer may be secured to the inner fabric layer along their respective top and side edges, while remaining unsecured along their respective bottom edges.

### CROSS-REFERENCE TO RELATED APPLICATION

This application claims the benefit of U.S. Provisional Patent Application Serial No. 62/542,651, filed on Aug. 8, 2017, which is incorporated herein by reference.

### FIELD DF THE INVENTION

The present invention relates to window curtains, and more particularly relates to light-blocking window curtains that are capable of blocking 100% of outside light.

### BACKGROUND INFORMATION

The window curtain industry has struggled to create affordable curtains that will truly block out 100% of light. Although attempts have been made, existing curtains do not pass the “flashlight test” where a flashlight is placed behind the curtain in the dark and no light is transmitted through the curtain. Accordingly, a need exists for window curtains having improved light-blocking capabilities.

### SUMMARY OF THE INVENTION

Light-blocking window curtains are provided that include a light-blocking laminated layer comprising an outer fabric layer and a polymeric light-blocking layer, and an inner fabric layer spaced from the light-blocking laminated layer. The light-blocking laminated layer may be secured to the inner fabric layer along their respective top and side edges, while remaining unsecured along their respective bottom edges.

An aspect of the present invention is to provide a light-blocking window curtain comprising a light-blocking laminated layer comprising an outer fabric layer comprising a top edge, first and second side edges, a bottom edge, an inner face and an outer face and a polymeric light-blocking layer adhered to the inner face of the outer fabric layer, and an inner fabric layer comprising a top edge, first and second side edges, a bottom edge, an inner face and an outer face, wherein the top edge and the first and second side edges of the light-blocking laminated layer are secured to the top edge and the first and second side edges of the inner layer, and wherein the polymeric light-blocking layer adhered to the inner face of the outer fabric layer is spaced from the outer face of the inner fabric layer.

Another aspect of the present invention is to provide a method of making a light-blocking window curtain comprising laminating an outer fabric layer and a polymeric light-blocking layer together to form a light-blocking laminated layer, aligning the light-blocking laminated layer with the inner fabric layer, and securing top and side edges of the inner fabric layer to top and side edges of the light-blocking laminated layer.

These and other aspects of the present invention will be more apparent from the following description.

### BRIEF DESCRIPTION OF THE DRAWINGS

FIG. 1 is a front view of light-blocking curtain in accordance with an embodiment of the present invention.

FIG. 2 is a back view of the light-blocking curtain of FIG. 1.

FIG. 3 is a side-sectional view of the light-blocking taken through line 3-3 of FIG. 2.

FIG. 4 is a partially schematic side sectional view of a portion of a light-blocking curtain in accordance with an embodiment of the present invention.

### DETAILED DESCRIPTION

The light-blocking window curtains of the present invention prevent light from entering a room. The light-blocking window curtain consists of a multi-layer construction to provide the improved light-blocking results and performance. As used herein, the term “light-blocking” means that the present curtain or component layers thereof have little or no visible light transmittance as more fully described below.

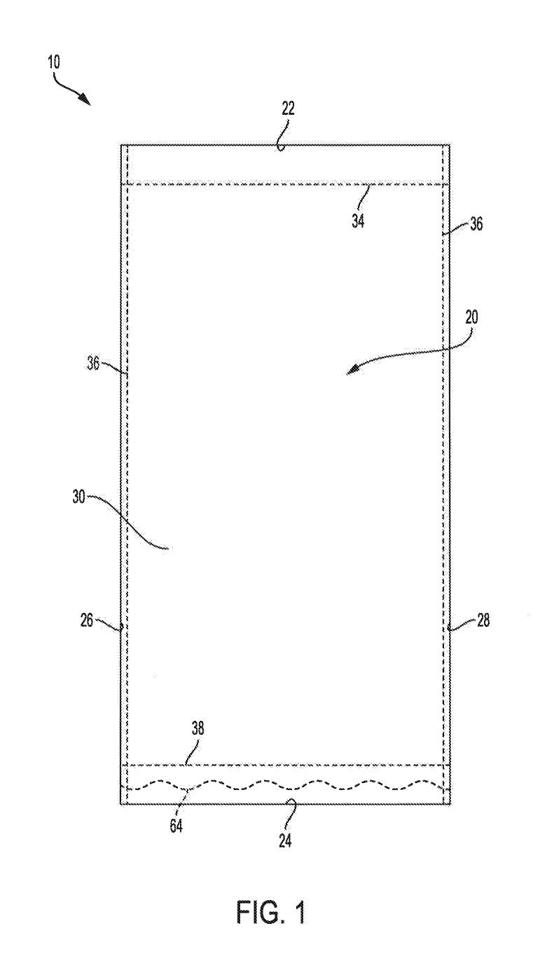

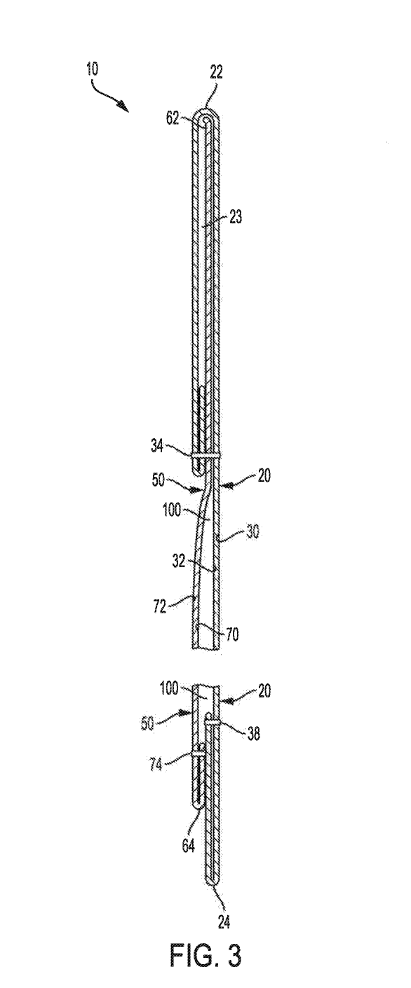

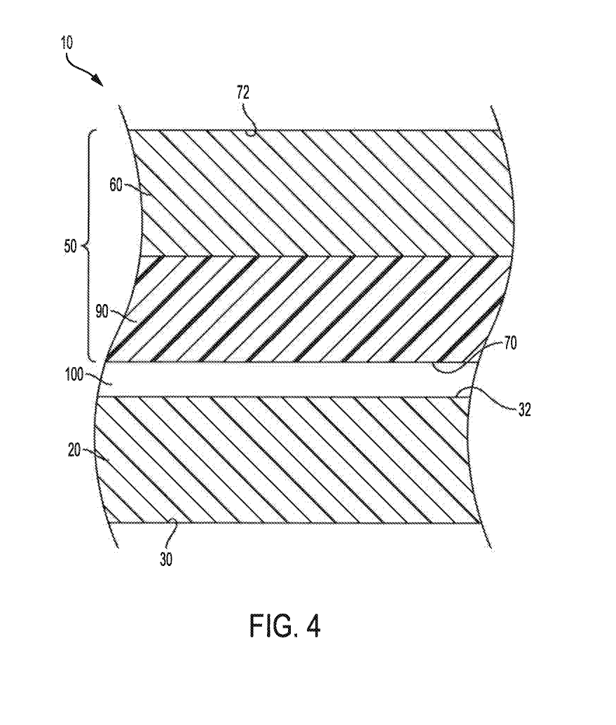

FIGS. 1-3 illustrate a light-blocking window curtain 10 in accordance with an embodiment of the present invention. The light-blocking window curtain includes an inner fabric layer 20 and a light-blocking laminated layer 50, and as shown in FIG. 4, the light-blocking laminated layer 50 comprises an outer fabric layer 60 and a light-blocking layer 90. As shown in FIGS. 1 and 3, the inner fabric layer 20 comprises a top edge 22, a bottom edge 24, first and second side edges 26 and 28, an inner face 30 and an outer face 32. As shown in FIGS. 3 and 4, the light-blocking laminated layer 50 comprises a top edge 62, a bottom edge 64, an inner face 70 and an outer face 72. When installed, the outer face 72 of the light-blocking laminated layer 50 may typically face toward a window or door, while the inner face 30 of the inner fabric layer 20 may typically face toward the room.

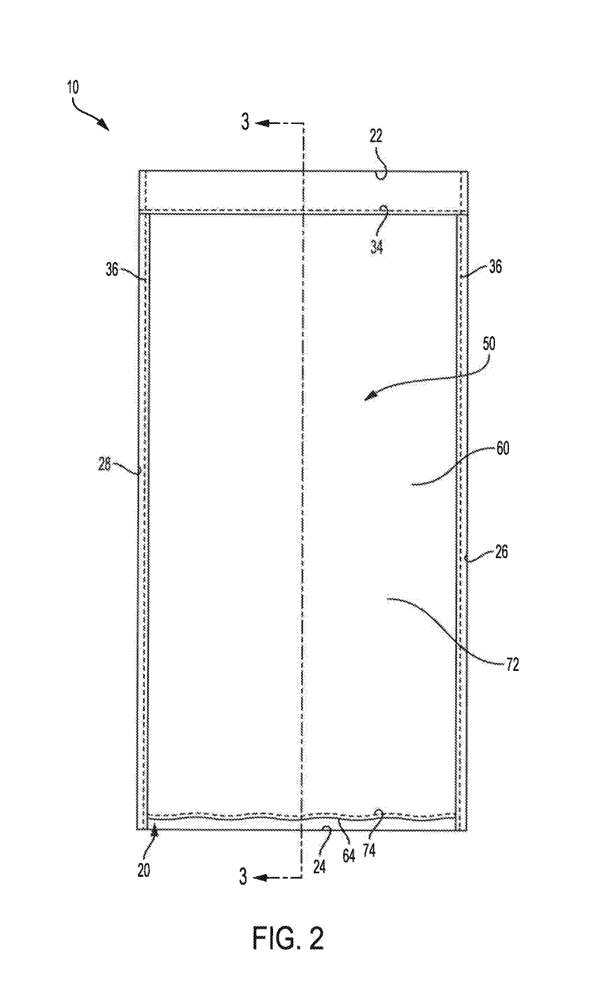

As shown in FIGS. 1-3, the top edge 22, the bottom edge 24 and the first and second side edges 26 and 28 of inner fabric layer 20 may be formed by hemming the inner fabric layer 20. As shown in FIG. 2, edges of the inner fabric layer 20 may be folded onto the outer face 32 and sewn to form the top edge 22, the bottom edge 24 and the first and second side edges 26 and 28 of inner fabric layer 20. In accordance with an embodiment of the present invention, the top hem 34 of the top edge 22 of the inner fabric layer 20 may form a rod pocket 23 structured and arranged to receive a conventional window curtain rod. However, as understood by those skilled in the art the rod pocket 23 of the inner fabric layer 20 may also be provided with holes and/or grommets to accommodate a conventional window curtain rod.

As shown in FIG. 2, the light-blocking laminated layer 50 may be sized to be secured by the hems 36 of the first and second side edges 26 and 28 and the top hem 34 of the top edge 22 of the inner fabric layer 20. In a particular embodiment, the light-blocking laminated layer 50 may be sewn into the side hems 36 of the first and second side edges 26 and 28 and the hem 34 of the top edge 22 of the inner fabric layer 20. In accordance with an embodiment of the present invention, the top and sides edges of the light-blocking laminated layer 50 may extend to top edge 22 and the first and second side edges 26 and 28 formed by the hems of the inner fabric layer 20. In accordance with an embodiment of the present invention, the entire length of the first and second side edges of the light-blocking laminated layer 50 may be secured by the side hems 36 of the first and second side edges 26 and 28 of the inner fabric layer 20. As shown in FIG. 3, the first and second side edges of the light-blocking laminated layer 50 may be secured by side hems 36 of the first and second side edges 26 and 28 of the inner fabric layer 20 in the rod pocket 23 formed by the hem 34 of the top edge 22 of the inner fabric layer 20. As shown in FIG. 3, the light-blocking laminated layer 50 may extend along the entire length of the rod pocket 23 formed by the hem 34 of the top edge 22 of the inner fabric layer 20. It is to be understood that while a certain size hems are shown in the figures, any other suitable size of hem may be used in accordance with an embodiment of the present invention.

In accordance with an embodiment of the present invention, the bottom edge 64 of the light-blocking laminated layer 50 may not be sewn into the bottom hem 38 of the bottom edge 24 of the inner fabric layer 20, as shown in FIGS. 1-3. As shown in FIGS. 2 and 3, the bottom edge 64 of the light-blocking laminated layer 50 may be formed by a hem bottom 74. In the embodiment shown, the bottom edge 64 of the light-blocking laminated layer 50 does not extend to the bottom edge 24 of the inner fabric layer 20. In accordance with an embodiment of the present invention, the bottom edge 64 of the light-blocking laminated layer 50 being free from the inner fabric layer 20 allows for the inner fabric layer 20 of the light-blocking window curtain 10 to properly drape when installed.

As shown in FIGS. 3 and 4, the light-blocking laminated layer 50 is spaced from the outer face 32 of the inner fabric layer 20 to provide an air gap 100. Thus, other than at the top edge 22 and side edges 26 and 28, the light-blocking laminated layer 50 is not sewn, adhered or otherwise attached to the outer face 32 of the inner fabric layer 20. The air gap 100 may provide increased thermal insulation for the curtain 10, and allows for the light-blocking window curtain 10 to properly drape when installed on a conventional curtain rod (not shown). The light-blocking laminated layer 50 is spaced from the outer face 32 of the inner fabric layer 20 except the first and second side edges of the light-blocking laminated layer 50 being secured by the hems 36 of the first and second side edges 26 and 28 of the inner fabric layer 20 and the top edge 62 being secured by the hem 34 of the top edge 22 of the inner fabric layer 20.

In accordance with an embodiment of the present invention, the light-blocking layer 90 may be adhered to the outer fabric layer 60 to form the inner face 70 of the light-blocking laminated layer 50. The light-blocking layer 90 may be adhered to the outer fabric layer 60 through a lamination process. The lamination process may use heat and/or pressure to combine the outer fabric layer 60 and the light-blocking layer 90 into the light-blocking laminated layer 50. For example, the polymeric light-blocking layer, or both the outer fabric layer 60 and the light-blocking layer 90, may be heated and passed through a nip-roller or other type of pressure-applying machine to thereby adhere the layers to each other. During the lamination process the light-blocking layer 90 may not significantly infiltrate the outer fabric layer 60, but is sufficiently adhered thereto to prevent delamination during use. In accordance with another embodiment of the present invention, the light-blocking layer 90 may be adhered to the outer fabric layer 60 by any suitable means, for example, by adhesives, sewing or the like.

In accordance with an embodiment of the present invention, the inner fabric layer 20 may be made from any suitable knitted, woven or other fabric material. The fabric of the inner fabric layer 20 may be of any desired type, weave construction, fiber content, or weight. In accordance with an embodiment of the present invention, the outer fabric layer 60 may be made from any suitable knitted, woven or other cloth or fabric material. The cloth or fabric material of the outer fabric layer 60 may be of any desired weave construction, fiber content, or weight.

In accordance with embodiments of the present invention, the light-blocking window curtain 10 possess combinations of light reflectance and light transmittance properties such that sunlight or other sources of visible light such as flashlights, lamps, etc. directed toward the outer surface 72 of the light-blocking laminated layer 50 do not pass through the light-blocking window curtain 10. For example, the light-blocking laminated layer 50 comprises a multi-layer system that prevents the transmission of visible light (380 to 780 nanometers) through the light-blocking laminated layer. As further described below, the outer fabric layer 60 of the light-blocking laminated layer 50 has properties selected to have a relatively high light reflectance value (LRV). As used herein, the term “light reflectance value” or “LRV” means the percentage of visible light that reflects from a surface. As further described below, the light-blocking layer 90 of the light-blocking laminated layer 50 has properties selected to minimize and substantially prevent visible light transmittance (YLT). As used herein, the term “visible light transmittance” or “VLT” means the percentage of visible light that passes through the layer or layers.

In certain embodiments, the outer fabric layer 60 of the light-blocking laminated layer 50 may be white in color. However, it is to be understood that any other suitable color, such as relatively light colors, may be used for the outer fabric layer 60. The outer fabric layer 60 may have a CIELAB color space L* value, which measures the lightness of the fabric, of greater than 50. For example, the CIELAB color space L* value of the outer fabric layer 60 may be greater than 60, or greater than 80, or greater than 90. In a particular embodiment, the outer fabric layer 60 may have a CIELAB color space L* value up to 100, i.e., white. In accordance with an embodiment of the present invention, the relatively light color of the outer fabric layer 60 may allow for light to be reflected so that a reduced amount of light reaches the underlying light-blocking layer 90. As such, the outer fabric layer 60 may have less absorbance and more reflectance than the light-blocking layer 90 of the light-blocking laminated layer 50.

In accordance with certain embodiments, the outer fabric layer 60 of the light-blocking laminated layer 50 may have a light reflectance value of at least 50 percent, or at least 60 percent, or at least 70 percent, or at least 80 percent, or at least 85 percent, as measured according to the ASTM E903 standard test. In accordance with an embodiment of the present invention, the relatively high light reflectance value of the outer fabric layer 60 may be provided by the color and type of material used for the outer fabric layer 60.

En accordance with an embodiment of the present invention, the material composition, thickness and color of the light-blocking layer 90 of the light-blocking laminated layer 50 are selected to substantially prevent visible light transmittance through the light-blocking layer 90, through the light-blocking laminated layer 50 and through the light-blocking window curtain 10. In accordance with an embodiment of the present invention, the light-blocking layer 90 may be a continuous film of any suitable polymeric material, such as polyurethane, polyethylene, polypropylene, polyvinyl chloride, polystyrene, nylon, polycarbonate, polytetrafluoroethylene, a combination thereof, or the like. In a particular embodiment, the polymeric material of the light-blocking layer 90 may be a polyurethane material. In an embodiment of the present invention, the light-blocking layer 90 may have a thickness of 0.005 to 0.2 mil, for example, from 0.01 to 0.1 mil, or from 0.015 to 0.07 mil. In accordance with an embodiment of the present invention, the light-blocking layer 90 may be black in color. However, it is to be understood that any other suitable dark color, such as dark blue, dark brown, dark gray and the like, may be used for the light-blocking layer 90.

In accordance with an embodiment of the present invention, the dark color of the light-blocking layer 90 may be provided by a light-absorbing pigment. In certain embodiments, the amount of the light-absorbing pigment may be from 0.1 to 25 weight percent based on the total weight of the polymeric material of the light-blocking layer 90 and the colored pigment. For example, the colored pigment may comprise from 1 to 20 weight percent, or from 4 to 12 weight percent, or from 6 to 8 weight percent. In accordance with an embodiment of the present invention, the light-absorbing pigment may comprise carbon black or dark pigments known to those skilled in the art. Providing dark pigments to the polymeric material of the light-blocking layer 90 allows the light-blocking layer 90 to be more absorbing of visual light as determined by the ASTM E903 standard test.

In certain embodiments, the light-blocking layer 90 may have a CIELAB color space L* value of less than 50. For example, the CIELAB color space L* value of the light-blocking layer 90 may be less than 40, or less than 20, or less than 10. The light-blocking layer 90 is typically significantly darker and has a lower light reflectance value than the outer fabric layer 60. In accordance with certain embodiments, the light-blocking layer 90 of the light-blocking laminated layer 50 may have a light reflectance value of less than 50 percent, or less than 30 percent, or less than 20 percent, or less than 10 percent, or less than or equal to 5 percent, as measured according to the ASTM E903 standard test. In certain embodiments of the present invention, the difference between the light reflectance value of the light-blocking layer 90 and the light reflectance value of the outer fabric layer 60 may be at least 10 percent, or at least 25 percent, or at least 50 percent. For example, when the outer fabric layer 60 has a light reflectance value of 90 percent and the light-blocking layer 90 has a light reflectance value of 10 percent, the difference between the light reflectance values is 80 percent.

In accordance with an embodiment of the present invention, the light-blocking layer 90 may be substantially free of reflective components, e.g., metal particles or flakes, mineral particles or flakes, reflective pigments, and the like. Thus, the light-blocking layer 90 does not rely primarily on light reflectance properties to achieve the light-blocking properties of the present light-blocking window curtain 10. Instead, the light-blocking layer 90 possesses sufficient light absorbing and/or low visible light transmittance properties that prevent the transmission of incident light through the light-blocking layer 90. This, in combination with the relatively high light reflectance properties of the outer fabric layer 60, provides a multi-layer system that prevents light transmission through the multiple layers.

In certain embodiments, the light-blocking layer 90 of the light-blocking laminated layer 50, the light-blocking laminated layer 50 and/or the light-blocking window curtain 10 may have a visible light transmittance of less than 1 percent, or less than 0.1 percent, or less than 0.01 percent, or less than 0.001 percent, as measured according to the ASTM E903 standard test. In one embodiment, the VLT of the light-blocking window curtain 10 is zero, as measured according to the ASTM E903 standard test. In accordance with an embodiment of the present invention, the low visible light transmittance of the light-blocking layer 90 may be provided by the color, thickness and type of material used for the light-blocking layer 90.

The light-blocking window curtain 10 may have any suitable dimensions and features, e.g., as found in conventional standard window curtains. The dimensions of the light-blocking window curtain 10 may be varied depending on the size of the window. For example, the width of the light-blocking window curtain may typically range from 1 to 15 feet, or from 2 to 10 feet, or from 3 to 6 feet. The length of the light-blocking window curtain may typically range from 2 to 20 feet, or from 3 to 15 feet, or from 4 to 12 feet. In an embodiment of the present invention, the light-blocking window curtain 10 may be used with any conventional window top treatment, and may be used with any conventional window hardware.

In accordance with an embodiment of the present invention, to make a light-blocking window curtain 10, the outer fabric layer 60 and the light-blocking layer 90 may be laminated together to form the light-blocking laminated layer 50. The bottom edge 64 of the light-blocking laminated layer 90 may be hemmed. The bottom edge 24 of the inner fabric layer 20 may be hemmed. The inner face 70 of the light-blocking laminated layer 50 is placed onto the outer face 32 of the inner fabric layer 20 with the first and second side edges of the light-blocking laminated layer 50 aligned with the first and second side edges 26 and 28 of inner fabric layer 20. The first and second side edges of the light-blocking laminated layer 50 may be secured by the hems of the first and second side edges 26 and 28 of inner fabric layer 20. The top edge 22 of the inner fabric layer 20 may be hemmed to form a rod pocket 23 and to secure the top edge 62 of the light-blocking laminated layer 50.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A light-blocking window curtain comprising:
a light-blocking laminated layer comprising an outer fabric layer comprising a top edge, first and second side edges, a bottom edge, an inner face and an outer face and a polymeric light-blocking layer adhered to the inner face of the outer fabric layer; and
an inner fabric layer comprising a top edge, first and second side edges, a bottom edge, an inner face and an outer face,
wherein the top edge and the first and second side edges of the light blocking laminated layer are secured to the top edge and the first and second side edges of the inner layer, and wherein the polymeric light-blocking layer adhered to the inner face of the outer fabric layer is spaced from the outer face of the inner fabric layer.

2. The light-blocking window curtain of claim 1, wherein the polymer of the polymeric light-blocking layer comprises polyurethane, polyethylene, polypropylene, polyvinyl chloride, polystyrene, nylon, polycarbonate, polytetrafluoroethylene, or a combination thereof.

3. The light-blocking window curtain of claim 1, wherein the polymeric light-blocking layer has a thickness from 0.005 to 0.2 mil.

4. The light-blocking window curtain of claim 1, wherein the polymeric light-blocking layer comprises a polymeric material having a CIELAB L* value of less than 50.

5. The light-blocking window curtain of claim 1, wherein the outer fabric layer comprises a woven or knitted fabric material having a CIELAB L* value of greater than 50.

6. The light-blocking window curtain of claim 1, wherein the light-blocking window curtain has a visible light transmittance of less than 0.01 percent.

7. The light-blocking window curtain of claim 1, wherein the light-blocking window curtain has a visible light transmittance of zero.

8. The light-blocking window curtain of claim 1, wherein the outer fabric layer has a light reflectance value of at least 70 percent.

9. The light-blocking window curtain of claim 1, wherein the polymeric light-blocking layer has a light reflectance value of less than 20 percent.

10. The light-blocking window curtain of claim 1, wherein the polymeric light-blocking layer has a light reflectance value that is at least 50 percent less than a light reflectance value of the outer fabric layer.

11. The light-blocking window curtain of claim 1, wherein the polymeric light-blocking layer is substantially free of reflective components.

12. The light-blocking window curtain of claim 1, wherein the inner fabric layer comprises a top edge hem, a first side edge hem, a second side edge hem and a bottom edge hem.

13. The light-blocking thermal line window curtain of claim 12, wherein the top edge hem is adjacent to a window curtain rod pocket.

14. The light-blocking window curtain of claim 13, wherein the light-blocking laminated layer is secured in the top edge hem, the first side edge hem and the second side edge hem of the inner fabric layer.

15. The light-blocking window curtain of claim 1, *herein the bottom edge of the light-blocking laminated layer does not extend to the bottom edge of the of the inner fabric layer.

16. The light-blocking window curtain of claim 1, wherein the light-blocking laminated layer comprises a bottom edge hem.

17. The light-blocking window curtain of claim 16, wherein the bottom edge hem of the light-blocking laminated layer is free from the inner fabric layer.

18. The light-blocking window curtain of claim 1, wherein the inner fabric layer comprises woven or knitted fabric material.

19. A method of making a light-blocking window curtain comprising:
laminating an outer fabric layer and a polymeric light-blocking layer together to form a light-blocking laminated layer;
aligning the light-blocking laminated layer with the inner fabric layer; and
securing top and side edges of the inner fabric layer to top and side edges of the light-blocking laminated layer.

20. The method of making a light-blocking window curtain of claim 19, wherein the top and side edges of the light-blocking laminated layer are hemmed into the top and side edges of the inner fabric layer.
